(19) United States
(12) Patent Application Publication
(10) Pub. No.: US 2017/0181386 A1
(43) Pub. Date: Jun. 29, 2017

(54) SEEDLING PROTECTION DEVICE

(71) Applicant: Frederick Jonathan Zusy, Durango, CO (US)

(72) Inventor: Frederick Jonathan Zusy, Durango, CO (US)

(21) Appl. No.: 14/982,067

(22) Filed: Dec. 29, 2015

(51) Int. Cl. A01G 13/02; A01G 13/10

(52) U.S. Cl. CPC A01G 13/0281; A01G 13/0293; A01G 13/10; A01G 13/0225; A01G 2013/002

(57) ABSTRACT

A plant protection apparatus includes a plurality of side panels. Each of the plurality of side panels includes a mesh portion and a width of each side panel is greater at a lower portion of the side panel than a width of each side panel at an upper portion of the side panel. A side portion of each side panel is operably connected to a side portion of another of the plurality of side panels thereby defining a boundaried area. A lid includes a mesh portion and a perimeter portion of the lid is operably connected to the upper portion of each side panel to yield a self-supporting plant enclosure.

### BACKGROUND

The technical field generally to which this application and the within-described invention applies relates to the protection of young or otherwise vulnerable plants growing outdoors naturally or in a planned garden or landscaped setting. Such plants, especially when in the form or developmental phase as seedlings, sprouts, “starts,” or as new transplants, are especially exposed to potential damage and destruction from various animals and insects, commonly referred to individually and/or collectively as “garden pests,” and are likewise susceptible to damaging effects from the more severe types of weather conditions and natural environmental elements that can occur or otherwise be present, such as high heat, intense sunlight, frost, heavy rain, falling or blowing debris, wind or hail. One of the main reasons young plants are so vulnerable to garden pests is that they can be especially tender and tasty during the above-referenced stages of development, and can provide a ready and desirable food source for garden pests that are able to gain access. The loss of and/or replacement of seedlings and other young or vulnerable plants destroyed or damaged by garden pests or natural-elements can be time-consuming, costly, dispiriting, and highly frustrating. There have heretofore been various attempts to fashion or create various implements, devices or other inventions to attempt to protect plants from these types of damages; however, many if not all of the current designs (whether or not presently commercially available) are bulky, cumbersome, costly, flimsy, heavy, ineffective, poorly designed or constructed, more appropriate for fully-developed plants rather than young plants, damaging or detrimental to plants in other unintended respects, and/or difficult to assemble, use, ship, transport, move about, and/or store. Therefore, further technological developments and inventions in this field which are not encumbered with such imperfections, limitations or difficulties are necessary and desirable.

### SUMMARY

One embodiment of the present application includes a plant (in the botanical sense) protection apparatus. Other embodiments include unique plant protection apparatuses, systems, and methods. Further embodiments, inventions, forms, objects, features, advantages, aspects, and benefits of the present application are otherwise set forth or become apparent from the descriptions, drawings and illustrations included herein.

### BRIEF DESCRIPTION OF THE DRAWINGS

The descriptions herein make reference to the accompanying drawings wherein like-referenced numerals refer to like parts, areas, placements, locations or physical positions throughout the several views, and wherein:

FIG. 1 is an illustrative embodiment of a plant protector, which can be assembled from various individual pieces, as described below, or made in one complete unit as a whole, as similarly described below.

FIG. 2 is an illustrative embodiment of a top panel or cover (also referred to as a “lid”) of a plant protector.

FIG. 3 is an illustrative embodiment of a side panel of a plant protector, with an attached, downwardly-protruding ground retention mechanism or member, also referred to as a “leg.”

FIG. 4 is a cut-away (enlarged, isolated) perspective of a portion of FIG. 3 (such portion being shown on FIG. 3 as 312), illustrating a tab and a tab receiving mechanism or member (also referred to as a “slot”).

FIG. 5 depicts an illustrative embodiment of a plurality of plant protectors in a collapsed or unassembled, stacked state.

FIG. 6 depicts an illustrative embodiment of a plurality of fully-assembled plant protectors in a stacked state (one inside the other).

FIG. 7 depicts an illustrative embodiment of a plurality of side panels as fully assembled and connected to one another to form an initial frame, but prior to the attachment thereto of a lid.

### DETAILED DESCRIPTION

For purposes of promoting an understanding of the principles, design and utility of the within invention, reference(s) will now be made to the embodiments illustrated in the accompanying drawings, as well as to additional and separate embodiments which are not in fact illustrated in such drawings, and specific language will be used to describe the same. It will nevertheless be understood that no limitation or diminution of the scope of the invention is thereby intended, and that any alterations, enhancements and/or further modifications regarding the illustrated device or the various embodiments thereof as described herein, and any further applications of the principles of the invention as illustrated or described herein, are hereby deemed and declared expressly or impliedly contemplated and included therein and herein as would normally or obviously occur to one skilled in the art to which the invention relates.

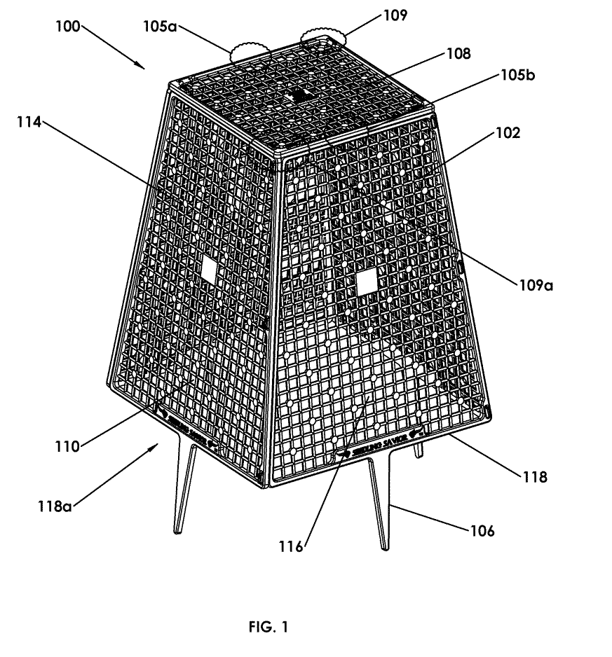

FIG. 1 illustrates one particular embodiment of the present invention. A fully-assembled plant protector 100 forms an open-air and substantially open-to-sunlight and open-to-moisture enclosure which can be placed over a plant, such as a seedling, and securely anchored/attached to the ground by use of the attached legs 106. The plant protector 100 can be utilized to provide protection to the plant from various animals, insects and other common garden pests, and can also be utilized to help shield the plant from intense sunlight and heat, heavy rains and downpours, wind, hail, supplemental frost-protection coverings, and blowing or falling debris. The fully-assembled plant protector enclosure 100, as shown, is constructed of a plurality of side panels 102 and a lid 108.

As is illustrated in FIGS. 1-3, the side panels 102 and lid 108 include within the interior area of their respective outside boundaries a gridded mesh or screening portion 114 (hereinafter sometimes referred to simply as “mesh”). In some forms, each of the side panels 102 and lid 108 are almost entirely constructed of a mesh area 114, as is shown in said illustrations. The additional non-mesh portions of the side panels and lid, including without limitation the somewhat thickened members 305, 314, 118, 320, 201 (also referred to herein as “sides,” “top rails” “bottom rails,” “edges” and/or “perimeters”) located along the outside perimeters of the side panel 102 and lid 108, can be used: (a) to assist in the manufacturing process 202, 202a, 204, 204a, (b) to provide support, strength, bracing and rigidity 305, 314, 118, 320, 201 to the overall enclosure 100, (c) to connect and attach the plurality of pieces to one another 208, 310 in order to form the overall plant protector enclosure 100, (d) to anchor and secure the overall structure to the ground 106, and (e) to provide an area for use in product marketing, trademark or patent status disclosure, and promotion 106a, 204.

The incorporation and use of the mesh construction 114 within the interior areas of the side panels 102 and lid 108 permits the plant protector 100 to provide protection to the plant from garden pests, while still allowing sufficient air, sunlight and moisture to freely penetrate the enclosure to provide nutrients and other natural elements necessary for the health and vigor of the growing plant enclosed by the plant protector 100. The mesh 114 can take or implement a variety of forms, thicknesses, dimensions, shapes, patterns, and spacings depending on the desired design and specific application of the user, as would be known or obvious to one of ordinary skill in the art.

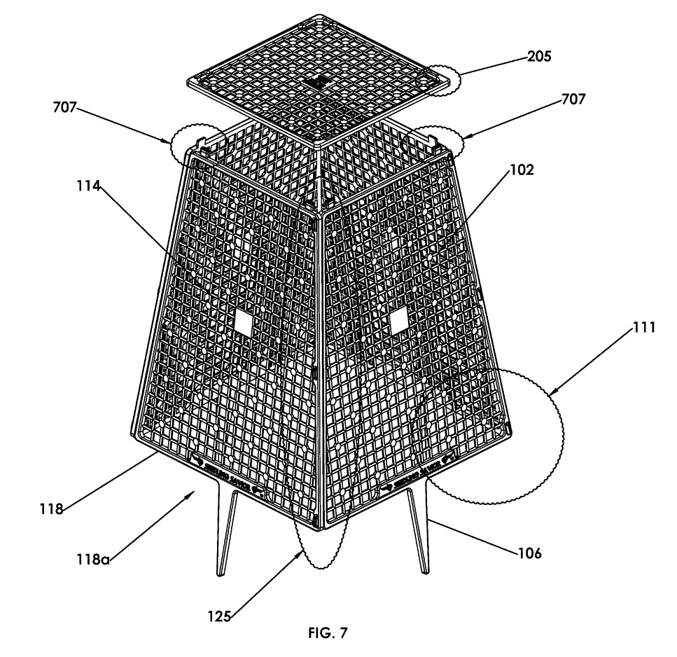

As mentioned, the meshed side panels and lid 102 and 108 can also include thickened members along their respective outside edges 305, 314, 118, 320, 201 to provide for a rigid and strengthened construction (the ultimate thicknesses, dimensions and particular shapes for which can provide an array of differing levels of rigidity and strength, as desired by the user). In addition, the bottom rails 118 of the side panels 102, when fully assembled as shown in FIGS. 1 and 7, will provide a firm, ground-level base of support for the plant protector 100 when in use. The rigidity of the illustrated side panels 102 and lid 108 is such that, when they are connected and attached together to form the plant protector 100, the overall plant protector 100 becomes a unified, integrally-connected structure that is self-supporting and self-bracing, the strength and rigidity of which is made especially more so when the slightly-angled legs 106 are properly and fully positioned in the ground.

As would be understood by or obvious to one of ordinary skill in the art, the desired overall rigidity, size, shape, weight, mesh opening sizes, and ultimate specific design of the side panels and lid 102 and 108, including without limitation the size, length, thickness and angle of the attached legs 106, can depend upon individual user requirements or desires, including, but not limited to, in the first instance: (a) the size, foraging habits, prevalence, sensory capabilities, aggressiveness, physical strength and capabilities, mobility, ambulatory capabilities, and specific type(s) of garden pests desired to be excluded and against which protection is sought, and (b) the type, prevalence and intensity of local weather conditions and other natural outdoor environmental elements from which protection is sought. Additionally, the overall size and design of the side panels 102 and lid 108, and of the mesh 114, can depend upon, in the second instance: (a) the size, number and/or spacing of the seedling(s) or plant(s) desired to be protected by the plant protector 100 at the time the plant protector 100 is first applied, (b) the horticultural needs, ongoing vulnerability, and growth characteristics of the plant during the time it is expected to remain protected within the enclosure, and (c) the overall anticipated height and girth of the plant at the time the user expects to remove the plant protector 100 from continued use; all as would be known or obvious to one of ordinary skill in the art.

The side panels 102 and lid 108, as well as the overall plant protector 100, can be constructed and/or manufactured utilizing a variety of techniques, methods and materials in order to obtain the utility for which they and it are designed and intended. It is contemplated, for example, that the side panels 102 and lid 108 can be constructed of one or more pieces of metal (and of one or more types of metal) through, for example, a stamping, pressing, cutting, molding and/or folding process or other forming techniques as would be understood by one of ordinary skill in the art. In another form, it is contemplated that the side panels 102 and lid 108, as well as the overall plant protector 100, can be constructed of a polymer such as plastic or resin, whether in one piece or from a plurality of individual and separate pieces. In one specific embodiment, as detailed and illustrated in this application, the side panels 102 and lid 108 are formed via plastic injection molding. However, it should be appreciated that other materials and forming and construction techniques suitable to yield the side panels 102 and lid 108, as well as the overall plant protector 100, are herein contemplated within the scope of the present invention, as would be known or obvious to one of ordinary skill in the art.

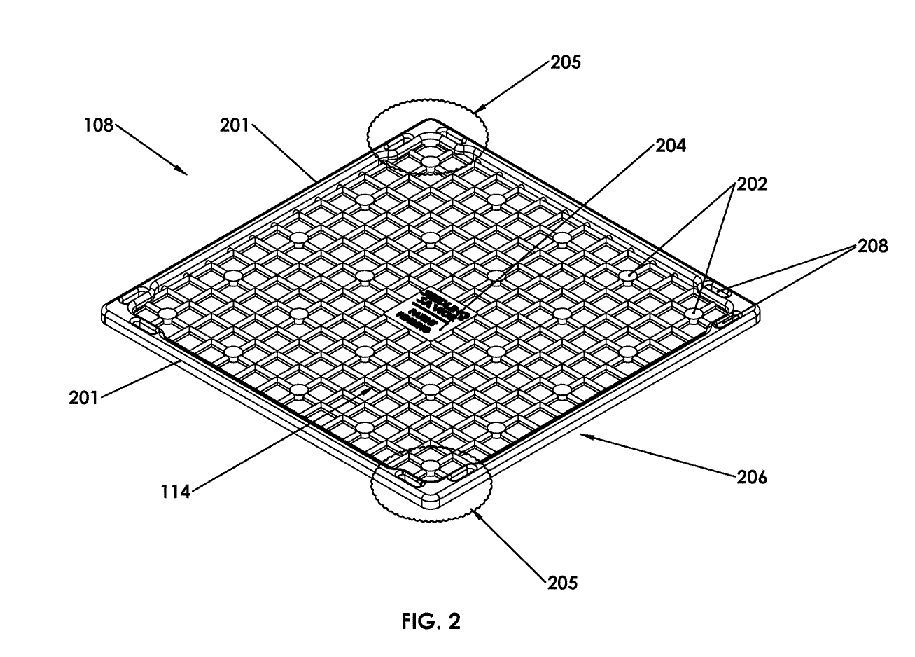

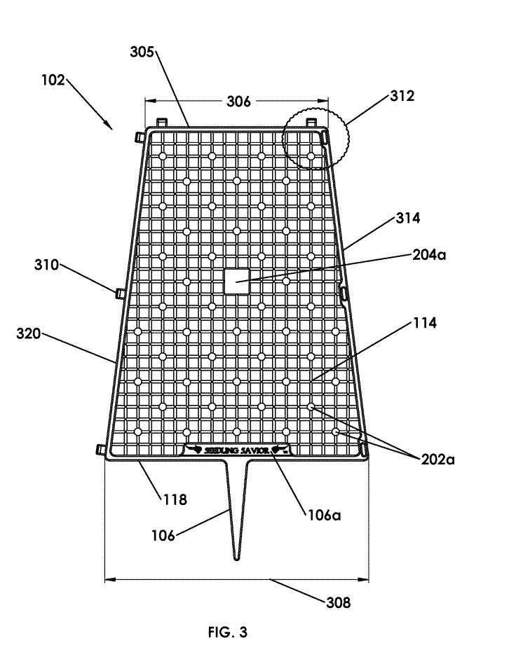

FIGS. 2 and 3 illustrate one embodiment of a side panel 102 and one embodiment of a lid 108, respectively, each formed of injection molded plastic. An injection site (injection point) 204, 204a is illustrated for each piece, where molten plastic is injected into a mold to spread throughout and fill a pre-formed cavity within the mold. Although the injection points 204 and 204a are illustrated in FIGS. 2 and 3, respectively, as having a square shape and as centrally located within the respective mesh 114 areas, the injection points 204 and 204a could also be of a different size or shape, and could be positioned at another location within or leading to the respective mold cavities of the side panel 102 and lid 108. A plurality of ejection pin points 202, 202a can be disposed throughout the mesh portions 114 in the side panels and lids 102, 108, at various intersection points of the mesh 114 and in a variety of patterns and/or spacing. These ejection pin points 202, 202a allow for and assist with the ejection of the respective injection-molded pieces from the respective molds after the polymer has at least partially set. As can be appreciated, the ultimate location, size, shape and number of ejection pin points 202, 202a can depend on various design and specific manufacturing aspects that are selected or desired, including but not limited to, the type of polymer used (including any additives) and the physical characteristics thereof, the strength, size and spacing of the formed mesh, as well as the overall dimensions of the desired plant protector 100.

Referencing FIG. 3, and as mentioned above, one embodiment of a representative side panel 102 formed of injection molded plastic is illustrated. As shown, the width (horizontal distance) 306 of the top rail 305 of the side panel 102 is less than and centered-symmetrical to the width (horizontal distance) 308 of the bottom rail 118 of the side panel 102, thereby creating an angle away from vertical when moving from one of the far ends of the top rail to the opposing far end of the bottom rail along the outside edges of the side panel 102, and thereby giving the side panel 102 an overall trapezoidal shape. See FIG. 3.

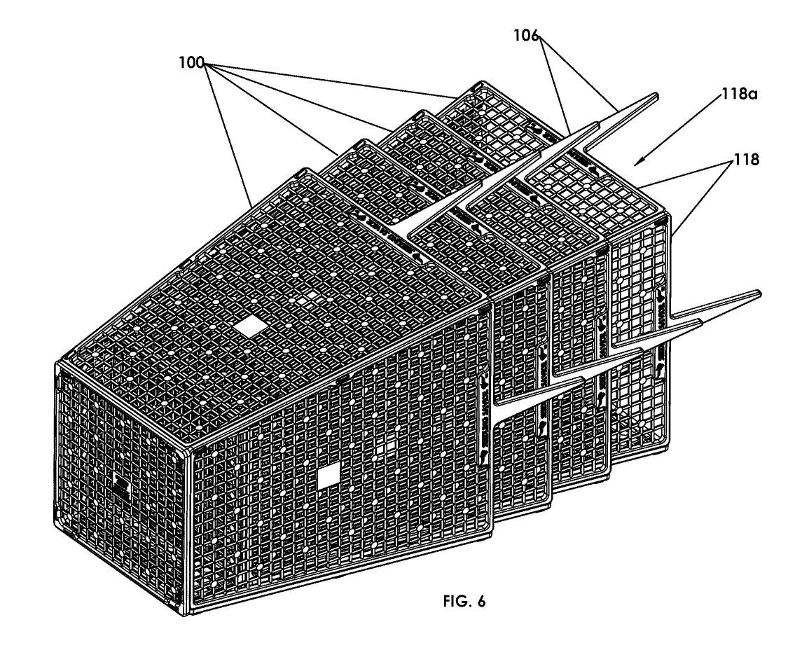

The smaller width 306 of the top rail 305 relative to the larger width 308 of the bottom rail 118, i.e., the trapezoidal shape of the side panel 102, permits a plurality of plant protectors 100, once assembled, to be stacked one on top of and/or one inside of the other for more efficient storage and transport of the plant protectors 100 when not in use. See, e.g., FIG. 6. This is because the trapezoidal shape of the side panel 102, when attached to and connected with a plurality of additional side panels 102 in the manner illustrated, will create an overall “flat-topped” 4-sided pyramidal shape. See, e.g., FIGS. 1, 6 and 7. Referring to FIGS. 1 and 6, the square, top portion 108 of one plant protector 100 can be placed within the square, open-air bottom base area 118a (defined by the plurality of bottom rails 118 of the connected plurality of side panels 102) of a second plant protector 100, such that the first plant protector 100, when pushed or placed completely into the open-air interior space of the second plant protector 100, will fit symmetrically within said space, and will securely nest within the second plant protector 100. See FIG. 6. As mentioned, this nesting and stacking capability of a plurality of plant protectors 100 will allow for ease of storage, transport and/or shipping of said plurality when not in use. In addition to the benefits obtained from the aforementioned symmetrical stacking capability, the trapezoidal shape of the side panels 102, when fully assembled with a plurality of other side panels 102 and a lid 108 into a complete plant protector 100, also creates an angle away from vertical for the legs 106 when placed into the ground, thereby increasing the strength and resistance capabilities of the overall plant protector 100 when and if lateral forces are applied thereto (i.e., it will be more difficult for a garden pest animal to lift it from the ground, knock it over, or pull it over).

It must be stated, however, that the respective trapezoidal and flat-topped pyramidal shapes of the side panel 102 and the overall plant protector 100 as illustrated in this application are not required for the overall utility and/or functionality of the invention. Rather, different shapes and sizes of the side panels 102 and of the overall plant protector 100 may be implemented and used in an unlimited variety of additional embodiments, including as an example but without limitation, by using square-shaped or rectangular-shaped side panels 102, which if implemented and assembled into an overall design would thereby create a cube-shaped or box-shaped structure for the overall plant protector 100. As a result of the particular embodiment used as an example, square-, rectangular-, cubed- or box-shaped plant protectors 100 would not be able to fit one inside the other unless they were of different overall shapes and/or sizes.

Furthermore, the plant protector 100 does not need to include any built-in legs 106 or other ground retention devices in order to retain the basic utility or functionality intended for the overall invention. Although it would likely provide less security if larger or stronger types of garden pests were present, an embodiment of the plant protector 100 without built-in ground retention devices would nevertheless provide some level of protection from smaller garden pests (and from the elements) even if used without such built-in ground retention devices. Additionally, an embodiment of the plant protector 100 without built-in ground retention devices could provide substantial protection from garden pests and from the elements if alternative or supplemental ground retention devices, such as “j-hooks,” tent-type stakes or weighted items, were used to help hold the plant protector 100 in place.

However, the plant protector 100 will provide the most favorable and dependable protections, as well as ease of use, if at least one or a plurality of ground retention devices or members, such as the illustrated legs 106, are built-in and integrated to the plant protector 100. The embodiment of the plant protector 100 as depicted in this application includes such built-in ground retention members or “legs” 106. See FIGS. 1 and 3. The leg 106 extends downwardly from the base or bottom rail 118 of at least one of the side panels 102. It can so extend downwardly from any point along the horizontal base rail 118 of the side panel 102. In one form, as shown in FIGS. 1 and 3, each side panel 102 can include a leg or ground retention member 106 that extends downwardly from the center point of the horizontal base rail 118 of the side panel 102. Using such center point for the attachment and downward extension of the leg 106 allows the user of the plant protector 100 to apply the maximum amount of downward force and pressure to the overall structure in order to properly seat the legs 106 into the ground when initially used and positioned above the plant to be protected. If the user finds the ground to be dry or compacted when attempting to place the plant protector 100, however, the user is advised to first make small pilot holes in the ground at the spot of each leg tip 106, using a pointed hand tool, so as to allow the legs 106 to more easily penetrate into the ground and to avoid putting undue pressure thereon. In fact, using such center point of the bottom rail 118 of the side panel 102 for the point of attachment and downward extension of the leg 106 also allows the assembler of the plant protector 100 to gain substantial increased support for the base of the plant protector 100 during the assembly process, and especially at the point in such process when the lid 108 is attached to the frame of the plurality of side panels 102, as more particularly discussed below.

The ground retention member (or leg) 106, as its descriptive name implies, is structured and designed to hold the overall plant protection enclosure 100 securely to the ground. Retaining the plant protection enclosure 100 securely to the ground will prevent movement of the plant protector 100 relative to the protected plant within the interior, thereby avoiding potential damage to the plant from undue contact with the plant protector 100, and secure retention can also prevent or deter animal garden pests from lifting or pulling on the plant protector 100 in an attempt to knock it over or to enter the enclosure. The specific design, shape, length and size of the ground retention member 106 can take a variety of forms, including, but not limited to a ground retention member in the general shape of a tine, stake, spear-head or arrowhead, pointed or barbed peg, or any other spiked-type shape, such that the ground retention member 106 can aid in the holding of the plant protector 100 securely to the ground.

Referring to FIGS. 1-3, the plurality of side panels 102 are connected together such that an interior boundaried area, the “base” area, 118a, is formed along and within the plurality of horizontal bottom rails 118 of the plurality of the side panels 102. This boundaried base area 118a defines the anticipated “ground-level” portion of the interior of the plant protection enclosure 100 as bounded by the horizontal bottom rails 118 of the plurality of connected side panels 102. The plurality of connected side panels 102 and the lid 108 (including the mesh 114 incorporated within same), when all properly attached to one another and properly secured to the ground with the legs 106, can prevent entrance to the interior of the plant protector enclosure 100 by a variety of common animal and insect garden pests, whether such entry is attempted through the sides or from the top of the plant protector enclosure 100 or from immediately underneath the horizontal bottom rails 118 of the side panels 102. Additionally, the side panels 102 act as integrated structural support for the overall plant protector 100.

A top panel, covering or “lid” 108 may or may not be used with the plant protector 100 as framed by a plurality of side panels 102. See FIG. 7. If the user elects to forego the use of a lid 108, the user will retain free and ready access to the interior of the plant protector 100 from above. Having such access could benefit or assist the user for purposes of ease of watering, fertilizing, weeding, thinning, mulching, pruning or providing other general plant maintenance or care to the plant being protected within the enclosure. However, electing to forego the use of a lid 108 would also allow free and ready access to the interior of the plant protector 100 from above by any garden pest capable of reaching, climbing to, crawling to, jumping to, or flying to the open top of the plant protector 100, which would likely be an unacceptable risk or otherwise undesirable to the user, as well as a significant departure from and a detriment to the overall protections designed to be afforded by the plant protector 100. Furthermore, an election to forego the use of a lid 108 would significantly limit the ability of the plant protector 100 to help shield the protected plant from the more severe elements, as it is designed to do, such as from intense sunshine or heat, heavy rains, wind, hail, or falling debris. Finally, an election to forego the use of a lid 108 could make it more difficult to gently and evenly push the legs 106 of the plant protector 100 into the ground.

As well, the user could elect to use the lid 108 or any other similarly-shaped or adapted covering device as an easily removable, unattached cover for the plant protector 100 as framed by a plurality of side panels 102, accomplishing such characteristics simply by forgoing the use of any attachment device or system for the lid, such as by electing not to use the built-in tab 310 and slot 208 attachment system that has been designed and incorporated into the side panels 102 and the lid 108 as shown in the embodiments depicted in this application. Such application and use of an unattached yet covering lid 108 would also provide the user with free and ready access to the interior of the plant protector 100 from above by simply removing the lid cover 108 temporarily, and would provide some level of shielding from the more extreme elements as mentioned above, but would nonetheless and in any event be more susceptible of being removed, displaced, lifted, or knocked away by larger, stronger or more aggressive or determined garden pests.

More robust and dependable protective capabilities can be enjoyed by the overall plant protector 100 by securely attaching the lid 108 to the frame of the assembled side panels 102 at a point on or along the length of at least one of the top horizontal rails 305 of at least one of the side panels 102. Such a “one-sided” attachment scheme can be accomplished by any practical method, such as by using supplemental wire ties or removable clips, by use of a hinge or hinges, or by use of other common types of attachment or clamping devices, and thereafter, depending upon the attachment method so used, the user could enjoy both ready and free access to the interior of the plant protector 100 from above (for the purposes identified above), and the plant protector 100 with a one-sided attached lid 108 would provide a much enhanced level of protection from access by garden pests and for shielding the plant from the more extreme elements (likewise as identified above).

The strongest and most dependable protective capabilities of the plant protector 100, however, can be achieved by securely attaching the lid 108 to the frame of the assembled plurality of side panels 102 at at least two oppositely-facing points along at least two of the top horizontal rails 305 of at least two of the side panels 102. For example, but without limitation, such secure, opposing attachments of the lid 108 to the side panels 102 could be made (a) at one of the top corners of the overall structure 109 where a corner of the lid 108 meets the top of the connected corner of two of the side panels 102, and then also at the opposite top cross-corner 109a, or (b) at the central point 105a of one horizontal top rail 305 of one side panel 102 and then also at the central point 105b of the horizontal top rail 305 of the opposing side panel 102. As mentioned, by securely attaching the lid 108 to the frame of the assembled plurality of side panels 102 at at least two points, the user gains the benefit of the strongest and most dependable protective capabilities of the plant protector 100, yet loses the ability to gain free and ready access to the interior of the plant protector 100 to perform such gardening tasks as weeding, thinning, mulching or pruning (while watering and fertilizing tasks can typically still be accomplished with the lid 108 in place). Such loss of ready access can be easily overcome, however, simply by temporarily removing the plant protector enclosure 100 from the ground, performing the tasks desired with respect to the protected plant and/or the interior base area 118a (such as weeding, thinning or pruning), and then replacing the plant protector 100 as it was prior to the temporary removal.

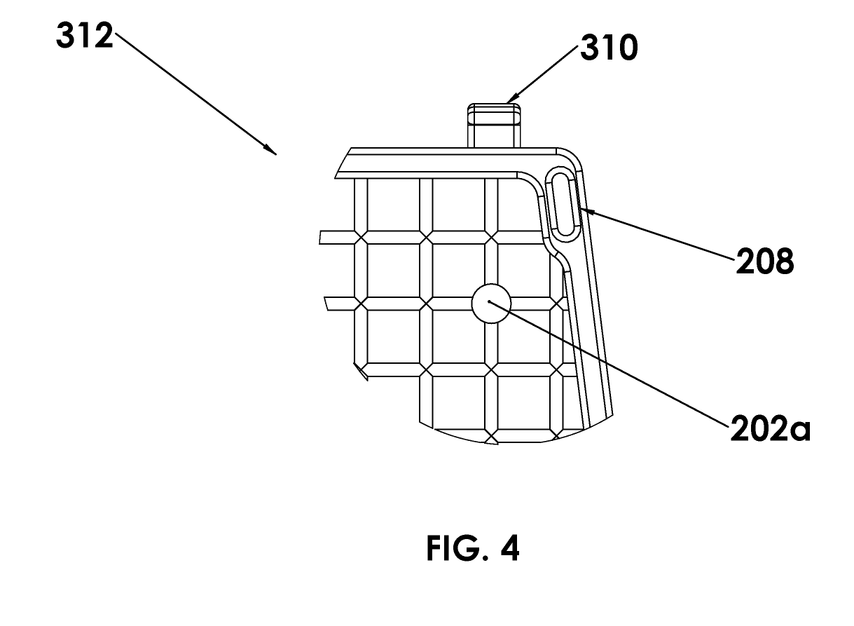

In one form as embodied in the depictions and illustrations herein, the entire perimeter portion 206 of the lid 108 can be easily, fully and securely attached and connected to the top horizontal rails 305 of each of the side panels 102, by use of a built-in tab 310 and slot 208 attachment system that has been designed and incorporated directly into the side panels 102 and the lid 108 as integral, polymeric parts thereof, without the need to use any additional or supplemental parts or connecting devices, and without the need to use any tools during the assembly process, all as is illustrated in FIGS. 1-4. The complete connection of the lid 108 to the frame of the plurality of side panels 102 by use of all eight pairings of the applicable tabs 310 and slots 208 yields a fully-assembled, freestanding, and ready-to-use plant protector 100. See FIG. 1. Maximum overall rigidity, shape- and form-retention capabilities, self-supporting capabilities, protective capabilities, and overall strength of the structure is attained through actual use thereof, when the plurality of legs 106 of the plant protector 100 are evenly, fully and securely placed into the ground.

In one form, the plant protector 100 is fully comprised as a unitary, one-piece structure that does not require further assembly or the use of supplemental parts, pieces or devices to obtain the overall design, i.e., it is comprised as a single complete unit ready for use. For example, but without limitation, and as would be known or obvious to one of normal skill in the art, with relatively slight engineering and technical modifications, revisions and/or enhancements, the individual configurations of the two separate mold cavities contemplated for use to manufacture the side panels 102 and the lid 108 as depicted herein by plastic injection molding, see FIGS. 1-3, could be combined and attached seamlessly to one another along the various lengths of the current attachment points through further and fairly simple CAD procedures to create a single cavity for a unitary, one piece, polymeric structure. In other words, the overall shape and design of the plant protector structure 100, as embodied in FIG. 1, could be easily re-drawn and re-engineered as a single unit rather than a multi-pieced enclosure assembled from a plurality of interlocking individual parts, and could be easily manufactured with a single larger mold, rather than two separate smaller molds. In addition, it should be understood that a variety of production and manufacturing processes, methods, materials and techniques can be utilized to yield a unitary one-piece plant protector 100, for example, but without limitation, by using metal or wire, screened or woven mesh, ceramics or glass, or any other malleable and structurally sound materials, and/or by using a process of bending, welding, stamping, pressing, molding, stapling, cutting, folding and/or any other commonly-known methods of shaping or forming such materials.

The form, design and method of attachment of the side panels 102 to one another, and of the lid 108 to the frame of a plurality of side panels 102, as embodied in the illustrations herein, and as described herein by reference to the built-in tab 310 and slot 208 integrated attachment system, is specifically designed and intended to create a “locking” feature or characteristic with respect to said system, so that, when a tab 310 is fully inserted into a slot 208, the head of the tab 310, being slightly thicker than the width of the slot 208, may pass through the slot 208 only with some small amount of straight-ahead or linear directional force and pressure being applied to the tab 310, and so that, once the head of the tab 310 is pushed fully through the slot 208, the head of the tab 310, after it emerges from the far side of the slot 208, will “lock” into place in a secure fashion, and whereby an effort to thereafter extract or remove the tab 310 from the slot 208 would be difficult at best, and in fact could require the use of a specialized leveraging or prying-type tool, as well as the need for specialized skill, to un-do or de-construct the original connection. In other words, the fully-assembled plant protector 100, in the form described and illustrated herein, see FIG. 1, is specifically intended and designed to be difficult to take apart by hand and/or to otherwise “collapse” it back into its individual plurality of pieces once it has been properly assembled and all of the plurality of pieces are properly connected. This “locking” feature of the tabs 310 and slots 208 provides added strength and rigidity to the overall plant protector enclosure 100, and gives added assurance to the user that the plant protector 100, when in use, will retain its shape and overall structural integrity even if small levels of external lateral forces are applied, and therefore the plant protector 100 will be made much more difficult to breach by an animal garden pest attempting to gain access. A final benefit of the “locking” feature makes it less likely that de-constructed individual pieces would be lost, misplaced or damaged when not in use.

In another form, the design and function of the attachment system to be used for the assembly of the plant protector 100 is such that the frame of the plurality of side panels 102 and the lid 108, once fully assembled and connected to one another, are more easily severable and retractable from one another, i.e., by not requiring the use of any special tool or skill, and as a result the overall structure can easily be collapsed back into the several individual and distinct plurality of pieces as existed at the beginning of the initial assembly process, and therefore which can be selectively coupled and decoupled at the will and desire of the user.

Referring to FIGS. 1-4, in one form the plurality of side panels 102 are attached to one another through a plurality of tabs 310 extending outward from the left-side edge 320 of each side panel 102, and a plurality of tab receiving members, or “slots” 208, are integrally positioned at identical but opposing locations along the right-side edge 314 of the side panel 102. See FIG. 3. To begin the assembly process, the user selects a “first” side panel 102 (shown as 116 in FIG. 1), and inserts the tabs 310 protruding from the left side edge 320 into and through the corresponding slots 208 of a “second” side panel 102 (shown as 110 in FIG. 1) until all of the plurality of tabs 310 of the first side panel 102 are fully engaged within and pushed through the plurality of corresponding slots 208 of the second side panel 102, thereby creating a fully assembled “corner” or “combined-corner rail” 125 with respect to the two just-connected side panels 102. The aforementioned assembly steps are then similarly repeated for the third and fourth side panels 102, and then also and finally with respect to the plurality of tabs 310 of the first side panel 102 being inserted into the plurality of corresponding slots 208 of the fourth side panel 102, thereby completing the 4-sided structural frame for the plant protector 100. See FIG. 7.

It should be noted here that a tab receiving member or slot 208 can take a variety of forms, shapes and sizes, such that the resulting aperture associated therewith can be structured to engage fully and securely with an inserted tab 310, thereby making it difficult to remove, or it can be structured to engage fully yet more loosely with an inserted tab 310, thereby making the tab 310 relatively easy to remove or retract from the slot 208 if desired by the user. The benefits and detractions of both of such attachment methods, and/or as may result from any compromise between or combination of the two, are as described hereinabove.

Referring to FIGS. 1-4 and 7, in one form the lid 108 is attached to the frame of a plurality of previously-attached and assembled side panels 102 by use of a plurality of tabs 310 extending upward from the top horizontal rail 305 of each side panel 102, and by using a plurality of tab receiving members, or “slots” 208, that are integrally positioned at corresponding pre-determined locations along the outside perimeter 206 of the lid 108. See FIGS. 1-4 and 7. To begin the process of attaching the lid 108 to the frame of a plurality of previously-attached and assembled side panels 102 (see FIG. 7), the assembler/user selects one of the corners 205 of the lid 108, and carefully positions the two slots 208 associated with that corner 205 directly above the two corresponding tabs 310 extending upward from each side of the top of the attached corner 707 created by two of the assembled side panels 102 making a part of the overall frame 125. See FIG. 7. When properly aligned and positioned, the two slots 208 of the selected lid corner 205 are gently pushed down and onto the heads of the two tabs 310 below 707, and with further gentle downward force (while at the same time also giving support to the corner 111 of the side panel 102 base so as not to put undue pressure on the legs 106), the tabs 310 of said side panels 102 are caused to pass fully through said slots 208, thereby engaging them and “locking” them into place 109. This procedure is then repeated sequentially for the other three corners 205 of the lid 108 with respect to the other three corresponding pairs of tabs 310 extending upwards from the other three top corners 707 of the assembled side panel 102 frame, as a result of which, when completed, the lid 108 will be fully secured and attached to the frame of the plurality of assembled side panels 102 around the entire perimeter 206 of the lid 108, and the plant protector 100 is now ready for use. See FIG. 1.

In one specific embodiment of the plant protector 100, the top horizontal rail 305 of a side panel 102 can include at least one or a plurality of tabs 310 extending upwards from said top rail 305, and similarly each side edge 201 of a corresponding lid 108 to be subsequently attached thereto can include at least one or a plurality of tab receiving members or slots 208. Similarly, a side panel 102 can include at least one or a plurality of tabs 310 extending outward from the left-side edge 320 of the side panel 102, and can include at least one or a plurality of corresponding and similarly-aligned slots 208 on the opposing, right-side edge 314 of the side panel 102. In another form, as depicted and illustrated herein: (a) each side panel 102 can include: (i) three tabs 310 extending outwardly from the left-side edge 320 of the side panel 102, and three similarly-aligned tab receiving members or slots 208 integrated within the right-side edge 314 of the side panel 102, and (ii) two tabs 310 extending upwardly from the top rail 305 of the side panel 102, and (b) each lid 108 can include two properly-aligned slots 208 on each side of the perimeter 206 of the lid 108, so that the lid 108 can be fully attached to the corresponding side panels 102 and tabs 310 thereof. See FIGS. 1-3.

It should be understood and noted that while certain specified tab 310 and slot 208 placements, numbers, and alignments have been particularly described for specific embodiments as referenced herein, the invention is not limited to or restricted by these particular or specific tab 310 and slot 208 placements, numbers and/or alignments as so described. Rather, any combination or number or plurality of tabs 310 and tab receiving members 208, and any variety, combination or alternatives of placements and/or alignments thereof in a final design, is expressly contemplated as being within the scope of the invention herein described, such that any such combination, number, plurality, variety or alternative with respect to the tabs 310 and slots 208 can ultimately be implemented in any design so as to cooperate with one another in order to assemble and connect the side panels 102 to one another and also to connect a frame of the assembled plurality of side panels 102 to the lid 108.

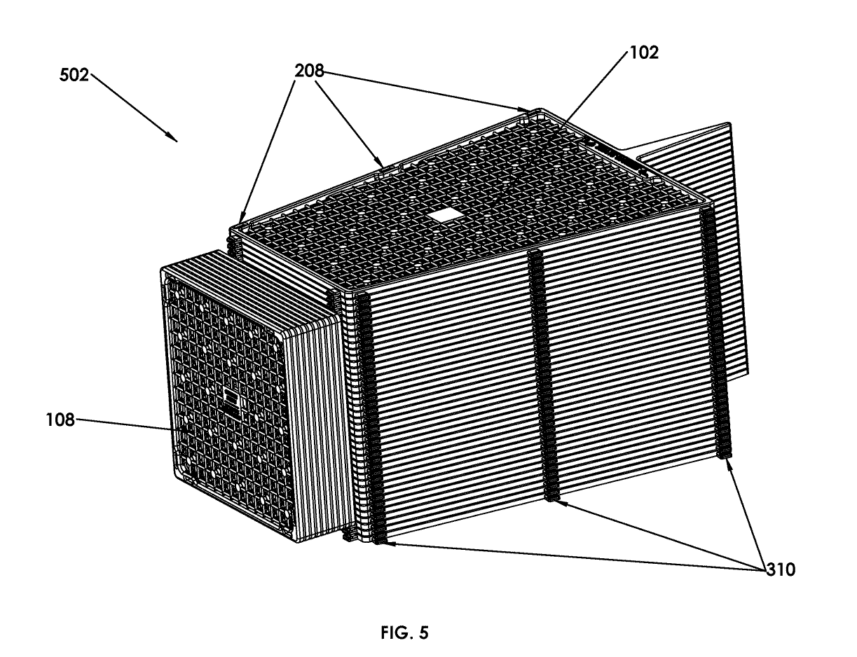

As was previously discussed, in one form the lid 108 and the side panels 102 can be decoupled from one another and collapsed into individual pieces. As well, when a plant protector 100 is first being assembled from a plurality of individual pieces, those pieces are first obtained by the assembler/user as individual, decoupled, separate pieces. FIG. 5 illustrates a plurality of decoupled and stacked side panels 102 and lids 108. In fact, this FIG. 5 also illustrates a stacked plurality of individual side panels 102 and individual lids 108 as they might appear immediately after being manufactured, and prior to any assembly procedures being undertaken. The capability of side panels 102 and lids 108 to be symmetrically and evenly stacked one on top of another while retaining a relatively low profile, whether done immediately after manufacture or whether done as a result of decoupling after a prior assembly, can provide ease of shipping, transport and storage. One example 502 of such a storage or shipping configuration, but without limitation, is as illustrated in FIG. 5, therein showing an assembled configuration of side panels 102 and lids 108 sufficient to construct ten separate plant protectors 100. As one of ordinary skill in the art can appreciate, any number or variety of possible stacking, shipping and/or storage configurations can be contemplated, depending upon the number of side panels 102 and/or lids 108 that are desired to be stacked, shipped and/or stored. In addition, one of ordinary skill in the art can likewise appreciate that the plurality of individual pieces of a collapsed and/or stacked plant protector 100 will take up much less overall space than a fully-assembled plant protector 100. Cf., FIGS. 1, 5 and 6.

While the invention herein has been described in connection with what is presently considered to be the most practical and preferred embodiment(s), it is to be understood that the invention is not to be limited to the disclosed embodiment(s), but on the contrary, is intended to cover various modifications and equivalent arrangements and structures included within the spirit and scope of the appended claims, which scope is to be accorded the broadest interpretation so as to encompass all such modifications and equivalent arrangements and structures as permitted under the law. Furthermore, it should be understood that while the use of the word preferable, preferably, or preferred in the description above indicates that the feature so described may be more desirable, it nonetheless may not be necessary to achieve the intended and desired functionality and utility of the invention, and any further or separate embodiment lacking the same shall therefore be contemplated as within the scope of the invention, that scope being defined by the claims that follow.

In reading and reviewing the foregoing descriptions, it is intended that when words or phrases such as “a,” “an,” “at least one” and/or “at least a portion” are used therein, there is no intention to limit the description to only one item or subject matter unless specifically stated to the contrary in the description. Further, when the phrases “at least a portion” and/or “a portion” are used in a description, the item or subject matter being referenced may include a portion and/or the entire item or subject matter, unless specifically stated to the contrary. Finally, when reference is made within a description to “a plant,” “the plant,” and/or “the protected plant,” such references shall be deemed to mean a plant in the botanical sense, and shall also be deemed to include a plurality of plants, such as “plants,” “the plants,” and/or “the protected plants.”

Further, in reading and reviewing the claims that follow, it is intended that when words or phrases such as “a,” “an,” “at least one” and/or “at least a portion” are used within a claim, there is no intention to limit the claim to only one item or subject matter unless specifically stated to the contrary in the claim. Further, when the phrases “at least a portion” and/or “a portion” are used in stating a claim, the item or subject matter being referenced may include a portion and/or the entire item or subject matter unless specifically stated to the contrary. Finally, if a claim makes reference to “a plant,” “the plant,” and/or “the protected plant,” such references shall be deemed to mean a plant in the botanical sense, and shall also be deemed to include a plurality of plants, such as “plants,” “the plants,” and/or “the protected plants.”

What is claimed is:

1. A plant protection apparatus, comprising:
a plurality of wall panels, wherein each of the plurality of wall panels includes a mesh portion, and wherein as the wall panels transition from an upper edge to a lower edge a width associated with the wall panels increases;
wherein a side portion of each wall panel is operably connected to a side portion of another of the plurality of wall panels thereby defining a boundaried area; and
a top panel including a mesh portion, wherein a perimeter portion of the top panel is operably connected to the upper portion of each wall panel to yield a self-supporting plant enclosure operable to protect a plant.

2. The plant protection apparatus of claim 1, wherein each wall panel comprises a substantially trapezoidal shape, and wherein the top panel comprises a substantially rectangular shape.

3. The plant protection apparatus of claim 1, further comprising a ground retention member extending downwardly from the lower edge of at least one of the plurality of wall panels at a central location of the wall panel.

4. The plant protection apparatus of claim 1, wherein the wall panels and the top panel form a unitary structure.

5. The plant protection apparatus of claim 1, wherein a first side portion of one of the plurality of wall panels further comprises at least one outwardly extending tab, wherein a second side portion of another of the plurality of wall panels further comprises a tab receiving member, and wherein the tab receiving member is structured to engage the tab such that the wall panels are removably connected to one another.

6. The plant protection apparatus of claim 5, wherein the upper edge of each of the plurality of wall panels further comprises an upwardly extending tab structured to removably connect with a plurality of tab receiving members located in a perimeter portion of the top panel.

7. The plant protection apparatus of claim 1, wherein at least one of the plurality of wall panels and the top panel include a plurality of mold ejection pin points located at mesh intersection points.

8. A method for forming a plant protector, comprising:
forming a plurality of rigid mesh wall panels, wherein each of the plurality of rigid mesh wall panels are substantially trapezoidal in shape, and wherein each of the plurality of rigid mesh wall panels are structured to couple to another of the rigid mesh wall panels to define a boundaried area; and
forming a rigid mesh top panel, wherein a perimeter portion of the rigid mesh top panel is structured to couple to a top portion of each of the plurality of rigid mesh wall panels such that a self-supporting plant enclosure is defined.

9. The method for forming a plant protector of claim 8, wherein forming the plurality of rigid mesh wall panels further comprises injecting polymer into a first mold structured to define each rigid mesh wall panel, and wherein forming the rigid mesh top panel further comprises injecting polymer into a second mold structured to define the rigid mesh top panel.

10. The method for forming a plant protector of claim 9, further comprising molding a plurality of ejection pin points at a plurality of mesh intersecting points.

11. The method for forming a plant protector of claim 8, further comprising forming at least one tab extending outwardly from a first side of a first rigid mesh wall panel and forming at least one tab receiving member in a first side portion of a second rigid mesh wall panel, wherein the at least one tab receiving member is structured to engage the at least one tab and thereby retain the first rigid mesh wall to the second rigid mesh wall.

12. The method for forming a plant protector of claim 11, further comprising forming at least one tab extending outwardly and upwardly from the upper portion of each of the rigid mesh wall panels and forming a plurality of tab receiving members in a perimeter of the rigid mesh top panel, wherein the tab receiving members of the rigid mesh top panel are structured to engage the tabs extending from the upper portions of the rigid mesh walls.

13. The method for forming a plant protector of claim 8, further comprising:
coupling the plurality of rigid mesh wall panels to define the walls of an enclosure through mating a plurality of tabs with a plurality of tab receiving members; and
coupling a perimeter portion of the rigid mesh top panel to the upper portions of the plurality of rigid mesh wall panels through mating a plurality of tabs extending from the upper portions of the rigid mesh wall panels with a plurality of tab receiving members in the perimeter portion of the rigid mesh top panel.

14. The method for forming a plant protector of claim 8, further comprising forming a ground retention member extending downwardly from the lower portion of at least one of the plurality of rigid mesh wall panels.

15. A plant protector apparatus, comprising:
a plurality of wall panels, wherein each of the plurality of wall panels is structured to connect to another of the plurality of wall panels such that a boundaried area is defined;
wherein each wall panel includes a greater width at a lower portion of the wall panel relative a width at an upper portion of the wall panel; and
a top panel structured to connect to the upper portion of each wall panel such that a self-supporting plant protection enclosure is thereby defined, and wherein each of the plurality of wall panels and the top panel include a mesh portion.

16. The plant protector apparatus of claim 15, wherein each of the plurality of wall panels includes at least one of a tab extending outwardly from a first side portion of the wall member and a tab receiving member located on a first side portion of the wall member, and wherein the tab receiving member on a first wall member is structured to selectively engage with the tab on a second wall member thereby connecting the first wall member to the second wall member.

17. The plant protection apparatus of claim 16, wherein each of the plurality of wall panels includes a tab extending outwardly from the first side of the wall panel and at least one tab receiving member located on an opposing side of the wall member.

18. The plant protection apparatus of claim 17, wherein the top panel further includes a plurality tab receiving members located on a perimeter portion of the top panel, and wherein the plurality of the tab receiving members is structured to connect with a plurality tabs extending upwardly from the top portion of each of the wall panels.

19. The plant protection apparatus of claim 15, wherein at least one of the plurality of wall panels further comprises a ground retention member extending downwardly from a lower portion of the wall panel.

20. The plant protection apparatus of claim 15, wherein each of the plurality of wall panels comprise a trapezoidal shape.
